(19) United States
(12) Patent Application Publication
(10) Pub. No.: US 2026/0012828 A1
(43) Pub. Date: Jan. 8, 2026

(54) PARTIAL OR SOFT GAP WITH VARIABLE GAP STARTING TIME AND LENGTH

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/764,051

(22) Filed: Jul. 3, 2024

(51) Int. Cl. H04W 24/10; H04L 1/00; H04W 8/18; H04W 72/231

(52) U.S. Cl. CPC H04W 24/10; H04L 1/0003; H04W 8/183; H04W 72/231

(57) ABSTRACT

A method for wireless communication at a user equipment (UE) and related apparatus are provided. In the method, the UE transmits an indication of support for a partial gap or a soft gap for measurement or multiple subscriber identity module (SIM) device (MSIM) tuning away; and receives, after the indication of the support, a configuration for the partial gap or the soft gap for the measurement or the MSIM tuning away. The UE further performs at least one measurement or the MSIM tuning away with a first portion of receive chains during the partial gap or the soft gap; and communicates with a serving cell or a first SIM using a second portion of the receive chains during the partial gap or the soft gap.

### TECHNICAL FIELD

The present disclosure relates generally to communication systems and, more particularly, to wireless communication including measurement gaps.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to transmit an indication of support for a partial gap or a soft gap for measurement or multiple subscriber identity module (SIM) device (MSIM) tuning away; receive, after the indication of the support, a configuration for the partial gap or the soft gap for the measurement or the MSIM tuning away; perform at least one measurement or the MSIM tuning away with a first portion of receive chains during the partial gap or the soft gap; and communicate with a serving cell or a first SIM using a second portion of the receive chains during the partial gap or the soft gap.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to receive, from a UE, an indication of support for a partial gap or a soft gap for measurement or MSIM tuning away; provide, after the indication of the support, a configuration for the partial gap or the soft gap for the measurement or the MSIM tuning away, where the configuration indicates for the UE to perform at least one measurement or the MSIM tuning away with a first portion of UE receive chains during the partial gap or the soft gap; and communicate with the UE based on a second portion of the UE receive chains during the partial gap or the soft gap.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extend reality (XR) flows.

FIG. 5 is a diagram illustrating an example of a discontinuous reception (DRX) cycle.

FIG. 6 is a diagram illustrating the collisions between the measurement gaps and XR traffic.

FIG. 7 is a diagram illustrating an example of using a partial gap or soft gap for measurement or multiple subscriber identify module (SIM) device (MSIM) tuning away in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

In wireless communication, a measurement gap is a time period when a device, such as a user equipment (UE), temporarily suspends its normal communication activities with its current serving cell to measure signals from other potential serving cells. The periodicity of measurement gaps may be aligned with the synchronization signal block (SSB) periodicity or the SSB measurement timing configuration (SMTC) window, or their multiples. For example, the periodicity of measurement gaps may be 20, 40, 80, or 160 milliseconds (ms). Extended reality (XR) applications may operate at frame rates of 30, 45, 60, 90, and 120 frames per second, corresponding to frame periodicities of 33.33, 22.22, 16.66, 11.11, and 8.33 milliseconds, respectively. The misalignment between the measurement gaps and XR data periodicity leads to collisions, which may impact the latency performance of XR applications. Additionally, a multiple subscriber identity module (MSIM) device may have time periods, known as tuning away, for operations such as paging monitoring, collecting system information blocks (SIBs), performing cell reselection or registration with another subscriber identity module (SIM). Similar to measurement gaps, misalignment between the MSIM tuning away and the XR data periodicity may negatively impact the performance of XR applications. Example aspects presented herein provide methods and apparatus that enable a partial or soft gap for measurement or MSIM tuning away.

Various aspects relate generally to wireless communication. Some aspects more specifically relate to wireless communication that includes measurement gaps or MSIM tuning away with variable gap starting time and length. In some examples, a UE transmits an indication of support for a partial gap or a soft gap for measurement or MSIM tuning away, and receives a configuration for the partial gap or the soft gap for the measurement or the MSIM tuning away. The UE further performs at least one measurement or the MSIM tuning away with a first portion of receive chains during the partial gap or the soft gap, and communicates with a serving cell or a first SIM using a second portion of the receive chains during the partial gap or the soft gap. In some examples, the UE may receive at least one of downlink control information (DCI) or a medium access control-control element (MAC-CE) indicating the partial gap or the soft gap, and the use of the second portion of the receive chains for communication during the partial gap or the soft gap may be based on reception of the DCI or the MAC-CE. In some examples, the UE may indicate, via radio resource control (RRC), a MAC-CE, or channel state information (CSI), a gap preference between the partial gap or the soft gap and a full gap or a hard gap. In some examples, the UE may determine a gap preference based on at least one of a radio frequency condition, a traffic throughput, a latency condition, or an artificial intelligence (AI) output.

Particular aspects of the subject matter described in this disclosure can be implemented to realize one or more of the following potential advantages. In some examples, by enabling a dynamic partial or soft gap based on needs and radio frequency conditions, such as varied XR traffic arrival times and volumes, the described techniques may avoid delays in transmitting XR traffic, while preserving the quality of inter-frequency and inter-radio access technology (IRAT) measurements, thereby enhancing flexibility and efficiency of wireless communication. In some examples, by enabling soft gaps that allow ongoing transmission with reduced resources compared to full gaps that include a complete suspension of communication, the described techniques may be used to maintain stable and uninterrupted wireless connections. In some examples, by allowing the adaptive switch between full and soft gaps based on the network conditions or device preferences, the described techniques optimize resource allocation, thereby enhancing overall network efficiency and user experience.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

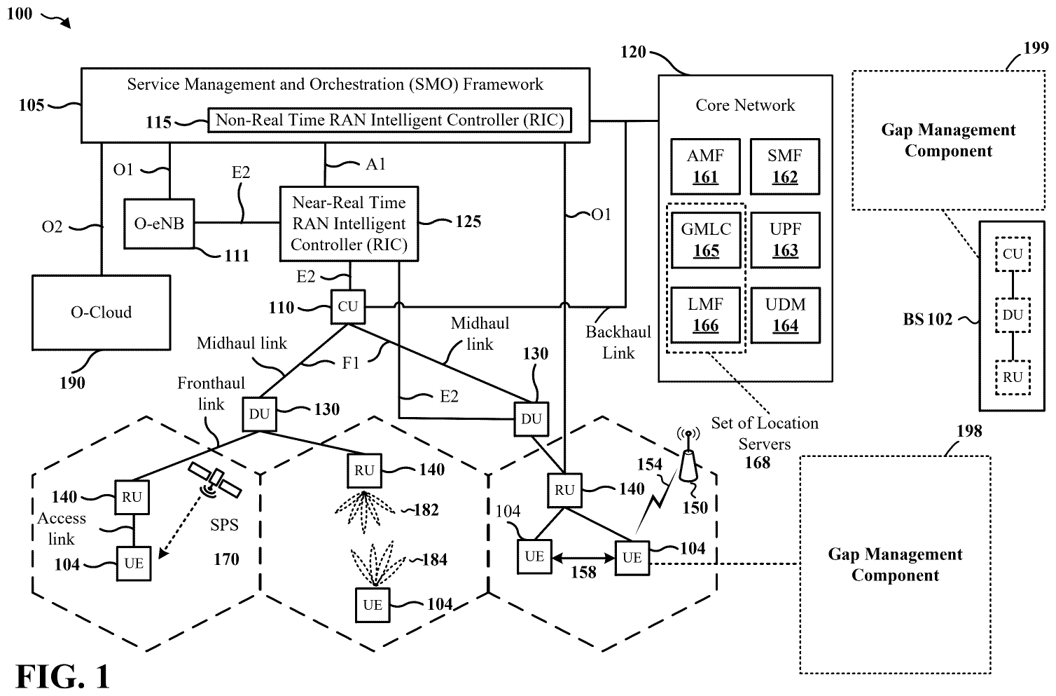

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the gap management component 198. The gap management component 198 may be configured to transmit an indication of support for a partial gap or a soft gap for measurement or MSIM tuning away; receive, after the indication of the support, a configuration for the partial gap or the soft gap for the measurement or the MSIM tuning away; perform at least one measurement or the MSIM tuning away with a first portion of receive chains during the partial gap or the soft gap; and communicate with a serving cell or a first SIM using a second portion of the receive chains during the partial gap or the soft gap. In certain aspects, the base station 102 may include the gap management component 199. The gap management component 199 may be configured to receive, from a UE, an indication of support for a partial gap or a soft gap for measurement or MSIM tuning away; provide, after the indication of the support, a configuration for the partial gap or the soft gap for the measurement or the MSIM tuning away, where the configuration indicates for the UE to perform at least one measurement or the MSIM tuning away with a first portion of UE receive chains during the partial gap or the soft gap; and communicate with the UE based on a second portion of the UE receive chains during the partial gap or the soft gap. Although the following description may be focused on 5G NR, the concepts described herein may be applicable to other similar areas, such as LTE, LTE-A, CDMA, GSM, and other wireless technologies.

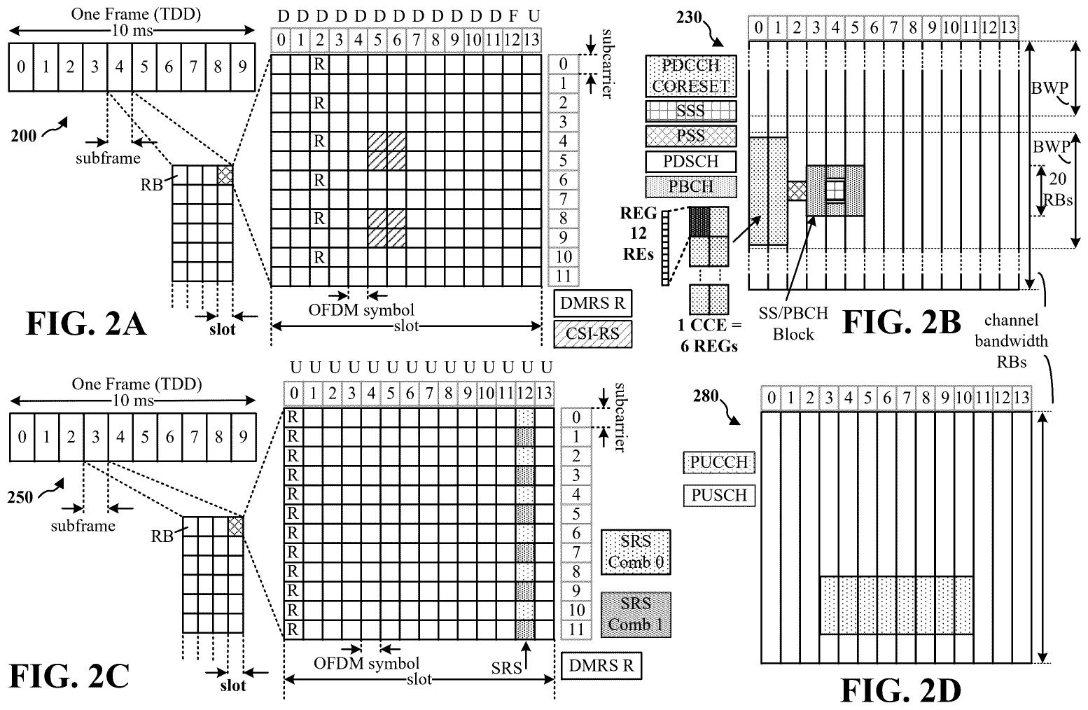

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

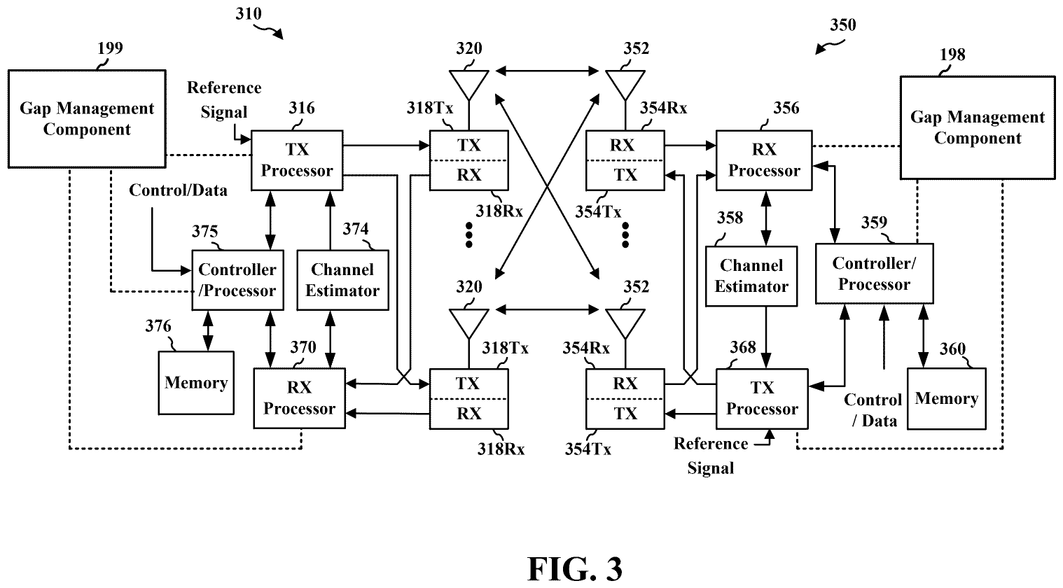

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the gap management component 198 of FIG. 1.

At least one of the TX processor 316, the RX processor 370, and the controller/processor 375 may be configured to perform aspects in connection with the gap management component 199 of FIG. 1.

The present disclosure provides methods and apparatuses that enable the UE to use partial receive chains for communication with the serving cell and for inter-frequency, inter-RAT neighbor measurement, based on traffic latency and RF conditions, and to dynamically switch between soft and hard gaps using mechanisms such as DCI or a MAC-CE.

XR traffic may refer to wireless communications for technologies such as virtual reality (VR), mixed reality (MR), and augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In some examples, an AR system may overlay sensory information (e.g., images) onto a natural environment and/or mask real objects from the natural environment. XR traffic may include video data and/or audio data. XR traffic may be transmitted by a base station and received by a UE, or the XR traffic may be transmitted by a UE and received by a base station.

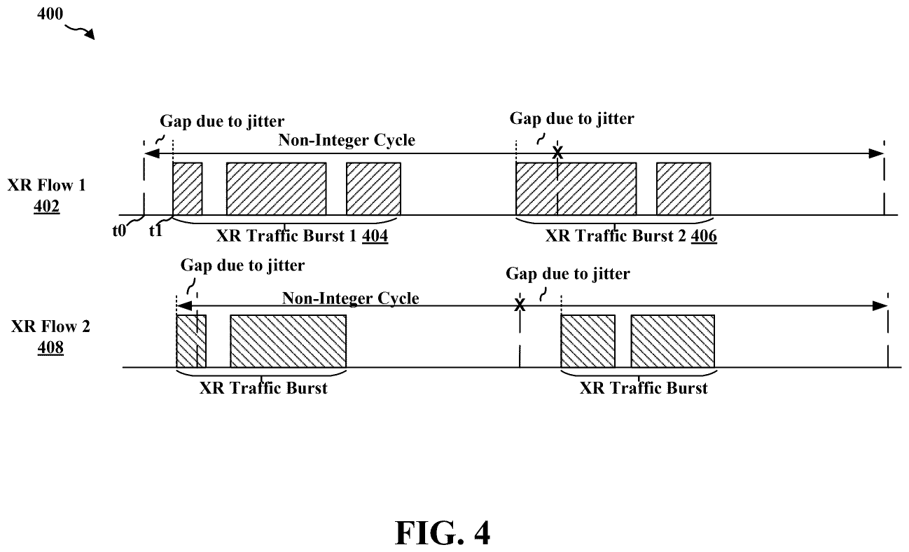

XR traffic may arrive in periodic traffic bursts (“XR traffic bursts” or “XR bursts”). An XR traffic burst may vary in a number of packets per burst and/or the size of each pack in the burst. The diagram 400 in FIG. 4 illustrates a first XR flow 402 that includes a first XR traffic burst 404 and a second XR traffic burst 406. As illustrated in the diagram 400, the traffic bursts may include different numbers of packets. For example, the first XR traffic burst 404 is shown with three packets (represented as rectangles in the diagram 400) and the second XR traffic burst 406 is shown with two packets. Furthermore, as illustrated in the diagram 400, the three packets in the first XR traffic burst 404 and the two packets in the second XR traffic burst 406 may vary in size. That is, packets within the first XR traffic burst 404 and the second XR traffic burst 406 may include varying amounts of data.

XR traffic bursts may arrive at non-integer periods (i.e., in a non-integer cycle). The periods may differ from an integer number of symbols, slots, etc. In one example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In one example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In one example, the first XR flow 402 may include video data, and the second XR flow 408 may include audio data for the video data. In another example, the first XR flow 402 may include intra-coded picture frames (I-frames) that include complete images, and the second XR flow 408 may include predicted picture frames (P-frames) that include changes from a previous image.

In RRC idle and inactive states, radio resource management (RRM) and paging consume significant UE power. For example, in RRM, the UE periodically performs layer 3 reference signal received power (L3-RSRP) measurements on synchronization signal blocks (SSBs) transmitted by a serving cell of the UE and neighbor cells of the UE. Such L3-RSRP measurements consume power. In another example, in paging, the UE periodically monitors a paging occasion (PO) during each idle discontinuous reception (I-DRX) cycle. In a DRX mode, the UE may monitor a PDCCH channel discontinuously using a sleep and wake cycle, e.g., DRX OFF durations and DRX ON durations. When the UE is in an RRC connected state, the DRX may also be referred to as connected mode DRX (CDRX). If the UE is in an RRC idle state, the DRX may be referred to as I-DRX. In a non-DRX mode, the UE monitors for PDCCH in each subframe to check whether there is downlink data available. Continuous monitoring of the PDCCH uses more battery power at the UE, and DRX conserves battery power at the UE.

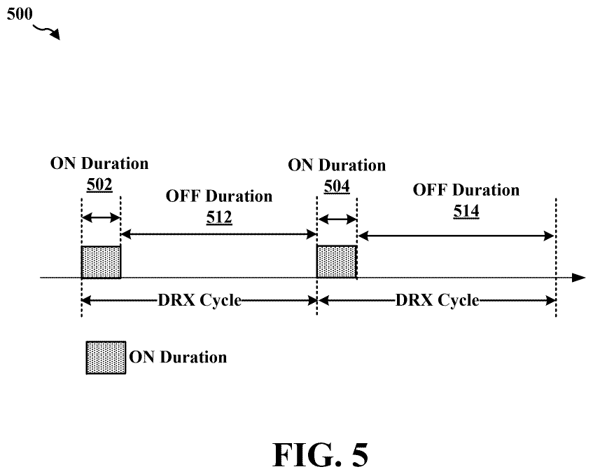

FIG. 5 illustrates an example of a DRX cycle 500. The DRX cycle may include periodic ON durations, such as ON duration 502, 504, during which the UE monitors for PDCCH and OFF durations, such as OFF duration 512, 514, during which the UE may not monitor for the PDCCH. The OFF duration, such as OFF duration 512, 514, may be referred to as a DRX opportunity, in some aspects. During the OFF duration, the UE does not monitor for PDCCH. The UE may enter a sleep mode or a low-power mode in which the UE minimizes power consumption by shutting down the radio frequency (RF) function without detecting communication from the base station.

In wireless communication, a measurement gap is a time period when a device, such as a UE, temporarily suspends its normal communication activities with its current serving cell to measure signals from other potential serving cells. The periodicity of measurement gaps may be designed to match with the SMTC window or SSB periodicity, or their multiples. For example, this periodicity may be set at intervals like 20, 40, 80, or 160 milliseconds. However, this periodicity may not be arbitrarily configured to match with the periodicity of XR traffic. For example, XR traffic may operate at frame rates of 30, 45, 60, 90, and 120 frames per second, corresponding to frame periodicities of 33.33, 22.22, 16.66, 11.11, and 8.33 milliseconds, respectively. The misalignment between the measurement gaps and XR data periodicity may lead to collisions, which may not be avoided by adjustments to the timing of these gaps or the XR data offsets. Such collisions may negatively impact the latency performance of XR applications.

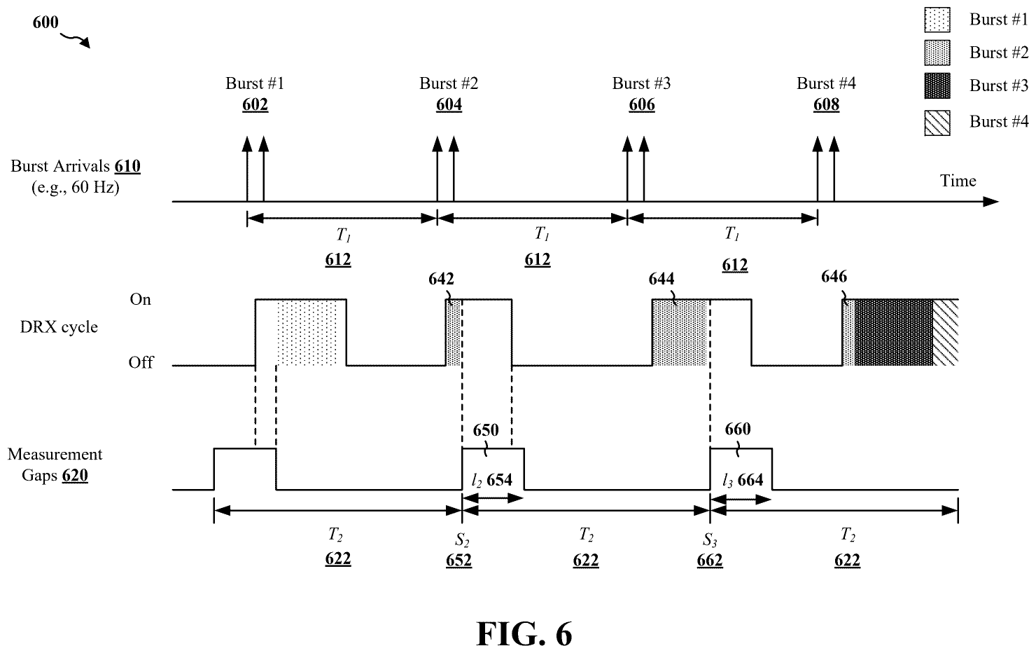

FIG. 6 is a diagram 600 illustrating the collisions between the measurement gaps and XR traffic. As shown in FIG. 6, the XR traffic 610 may include several burst traffic, such as burst #1 602, burst #2 604, burst #3 606, and burst #4 608. The XR traffic 610 may have a periodicity of T₁ 612. On the other hand, the measurement gaps 620 may have a periodicity of T₂ 622. For example, the time interval between the start time S₂ 652 of measurement gap 650 and the start time S₃ 662 of measurement gap 660 may be T₂ 622. The periodicity T₂ 622 may not be aligned with the periodicity of the XR traffic 610 (e.g., T₁ 612). For example, the XR traffic 610 may have a periodicity of 16.66 ms (i.e., T₁=16.66 ms), while the measurement gaps 620 may have a periodicity of 20 ms (i.e., T₂=20 ms). The collisions between the measurement gaps 620 and XR traffic 610 may increase the latency. For example, due to the collision between the measurement gaps 620 (e.g., measurement gap 650, 660) and XR traffic 610, the data transmission for burst #2 604 may be separated by measurement gap 650 (which has a gap length of l₂ 654) and measurement gap 660 (which has a gap length of l₃ 664) into multiple segments in the DRX ON cycles, such as the transmission segments 642, 644, 646, thereby increasing the latency of the transmission for burst #2 604. The increased latency may adversely impact the XR application, which may have a strict latency condition, such as a packet delay budge (PDB) of 10 ms (meaning all associated data packets need to be transmitted within a 10 ms window). In some examples, the network may be forced to abandon an entire frame of data due to the increased latency. In some examples, the measurement gaps themselves may be adjusted within a certain range, such as between 1.5 and 6 ms in length. This flexibility, however, is insufficient to prevent the negative impacts on XR traffic.

Additionally, an MSIM device may have time periods, known as tuning away, for operations such as paging monitoring, collecting SIBs, performing cell reselection or registration with another SIM. The MSIM device may suspend its normal communication activities during the tuning away. Similar to measurement gaps, misalignment between the MSIM tuning away and the XR data periodicity may negatively impact the performance of XR applications (e.g., increase the latency).

Example aspects presented herein provide methods and apparatus to address the collisions by implementing a “partial” gap or “soft” gap for measurement or MSIM tuning away. Unlike a “full gap” or “hard gap,” during which the UE completely suspends communication with the serving cell, the partial gap (or soft gap) allows the UE to simultaneously manage communication with the serving cell and perform other tasks (e.g., measurements or MSIM tuning away) using different portions of the receive chains. For example, during a partial gap (or soft gap), the UE may perform various measurements, such as an inter-frequency measurement; an Inter-Radio Access Technology (IRAT) measurement; a position measurement; or a cell global identity (CGI) measurement, using a portion of the UE receive chain. Meanwhile, the UE may use another portion of the receive chain for communication with the serving cell.

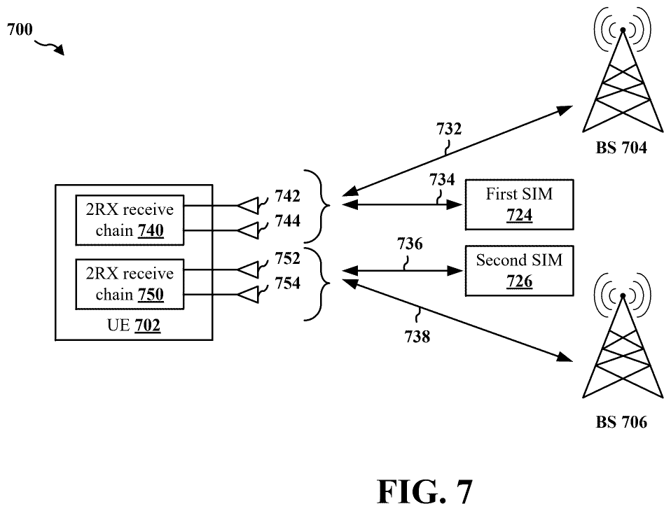

FIG. 7 is a diagram 700 illustrating an example of using a partial gap or soft gap for measurement or MSIM tuning away in accordance with various aspects of the present disclosure. In the example in FIG. 7, the UE 702 may have four receive chains, such as receive chains 742, 744, 752, and 754. The UE 702 may use two of these four receive chains, such as receive chains 742 and 744 (which may be collectively referred to as a 2RX receive chain 740), for communication with the serving cell (e.g., base station 704) at 732 or a first subscriber identity module (SIM) 724 at 734. Simultaneously, the UE 702 may use the other two receive chains, such as receive chains 752 and 754 (which may be collectively referred to as 2RX receive chain 750) for measurements or MSIM tuning away. For example, the UE 702 may use receive chains 752 and 754 to perform inter-frequency measurement or an IRAT measurement with another base station 706 at 736. For example, the UE 702 may use receive chains 752 and 754 to perform MSIM tuning away for paging monitoring, collecting SIBs, or performing cell reselection or registration with a second SIM 726 at 738.

In some examples, the base station 704 may enable and configure the partial or soft gap based on various factors such as a radio frequency condition, a traffic throughput, a latency condition. In some examples, the base station 704 may enable and configure the partial or soft gap based on an artificial intelligence (AI) output on the UE 702 or the base station 704. In some examples, base station 704 may send control information, via DCI or MAC-CE, to the UE 702, signaling the switch from using a full gap or a hard gap to a partial gap or a soft gap. In some examples, the base station 704 may adjust the multiple input multiple output (MIMO) layers or modulation and coding scheme (MCS) when UE 702 reduces the number of active receive chains for communication (e.g., when UE 702 uses two receive chains 752 and 754 for measurements or MSIM tuning away), further optimizing the communication during these gap periods.

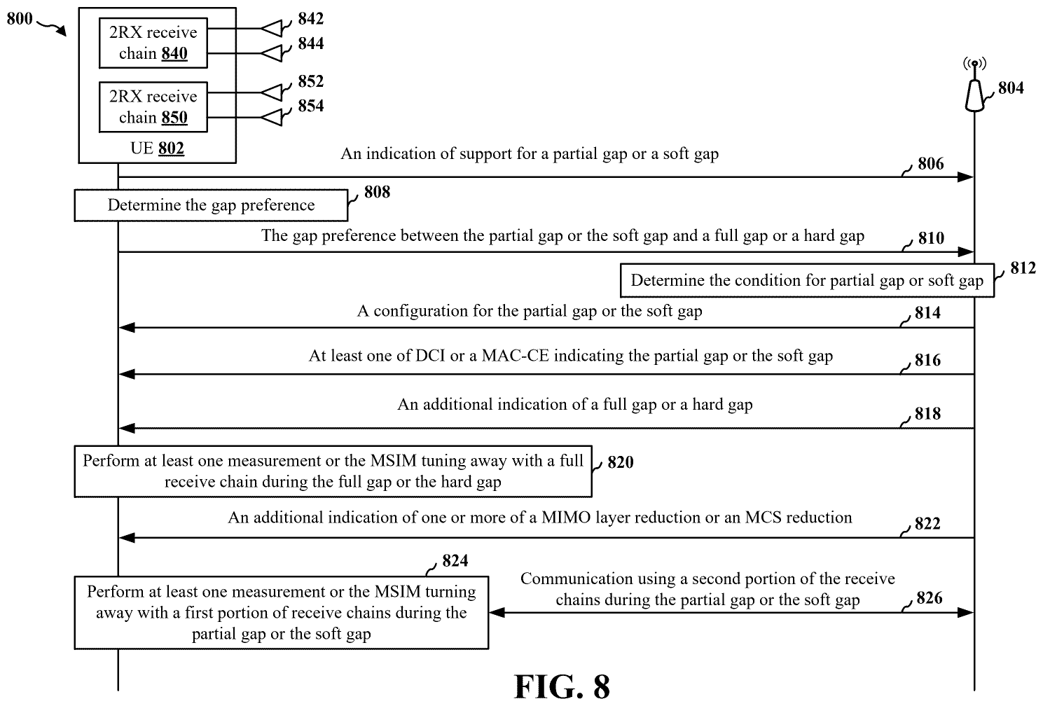

FIG. 8 is a call flow diagram 800 illustrating a method of wireless communication in accordance with various aspects of this present disclosure. Various aspects are described in connection with a UE 802 and a base station 804. The aspects may be performed by the UE 802 or the base station 804 in aggregation and/or by one or more components of a base station 804 (e.g., a CU 110, a DU 130, and/or an RU 140). The UE 802 may include multiple receive chains. In some examples, the UE 802 may include four receive chains, such as receive chains 842, 844, 852, 854. During a partial gap or a soft gap, the UE 802 may use two of these four receive chains, such as receive chains 842 and 844 (which may be collectively referred to as a 2RX receive chain 840) for communication with the serving cell, such as base station 804, and simultaneously use the other two receive chains, such as receive chains 852 and 854 (which may be collectively referred to as 2RX receive chain 850) for measurements for MSIM tuning away with neighbor cells.

As shown in FIG. 8, at 806, the UE 802 may transmit an indication of the support for a partial gap or a soft gap for measurement or MSIM tuning away to base station 804.

At 808, the UE 802 may determine a gap preference between the partial gap or the soft gap and a full gap or a hard gap. For example, the UE 802 may determine the gap preference based on at least one of a radio frequency condition, a traffic throughput, a latency condition, or an artificial intelligence (AI) output. For example, when the UE 802 is transmitting XR traffic, the latency condition associated with the XR traffic may be stricter compared to that of other types of traffic, and the UE 802 may determine to use a partial gap or soft gap (instead of a full gap) to facilitate the transmission of XR traffic.

At 810, the UE 802 may indicate the gap preference between the partial gap or the soft gap and a full gap or a hard gap to base station 804. For example, the UE 802 may indicate the gap preference via RRC, a MAC-CE, or channel state information (CSI), among others.

In some examples, after the base station 804 receives the UE's indication of the capability to support the partial gap or soft gap, the base station 804 may, at 812, determine whether the condition for using a partial gap or a soft gap has been met. For example, the condition may include a radio frequency condition, a traffic throughput, or a latency condition, among others.

At 814, the base station 804 may transmit to the UE 802 a configuration for the partial gap or the soft gap for the measurement or the MSIM tuning away. In some examples, the base station 804 may transmit to the UE 802 the configuration for the partial gap or the soft gap when the base station 804 determines (at 812) that the condition for using the partial of soft gap has been met.

At 816, the base station 804 may transmit to the UE 802 at least one of DCI or a MAC-CE indicating the partial gap or the soft gap. For example, the transmission of the DCI or the MAC-CE may be based on various factors, such as the RF condition, the arrival of traffic, the transmission timing for the reference signal for inter-frequency or IRAT measurements, or load balance, among others.

At 818, the base station 804 may transmit to the UE 802 an additional indication of a full gap or a hard gap. For example, when the base station 804 determines, at 812, that the condition for using the partial gap or soft gap is not met, the base station 804 may transmit to the UE 802 an additional indication of a full gap or a hard gap. In some examples, upon receiving the additional indication of a full gap or a hard gap at 818, the UE 802 may, at 820, perform at least one measurement or the MSIM tuning away with a full receive chain (e.g., receive chains 842, 844, 852, 854).

At 822, the UE 802 may receive an additional indication of one or more of a multiple input multiple output (MIMO) layer reduction or a modulation and coding scheme (MCS) reduction. In some examples, the communication during the partial gap or the soft gap (e.g., at 826) may be based on the one or more of the MIMO layer reduction or the MCS reduction. For example, the base station 804 may adjust the MIMO layers or MCS when UE 802 reduces the number of active receive chains for communication (e.g., when two receive chains 852 and 854 were used for measurements or MSIM tuning away).

At 824, the UE 802 may perform at least one measurement or the MSIM tuning away with a first portion of receive chains during the partial gap or the soft gap. For example, during the partial gap or the soft gap, the UE 802 may perform at least one measurement or the MSIM tuning away using receive chains 852 and 854 during the partial gap or the soft gap. Referring to FIG. 7, the UE 702 may perform at least one measurement or the MSIM tuning away with receive chains 752 and 754 during the partial gap or the soft gap. For example, the measurement may include an inter-frequency measurement; an IRAT measurement; a position measurement; or a CGI measurement. The MSIM tuning away may be performed for paging monitoring, collecting SIBs, performing cell reselection or registration with a second SIM 726.

At the same the UE 802 performing the measurement or the MSIM tuning away using the first portion of the receive chains at 824, the UE 802 may, at 826, communicate with the base station 804 or a first SIM using a second portion of the receive chains during the partial gap or the soft gap. For example, the UE 802 may communicate with the base station 804 using the receive chains 842 and 844 during the partial gap or the soft gap. Referring to FIG. 7, the UE 702 may communicate with the base station 704 or a first SIM 724 using the receive chains 742 and 744 during the partial gap or the soft gap.

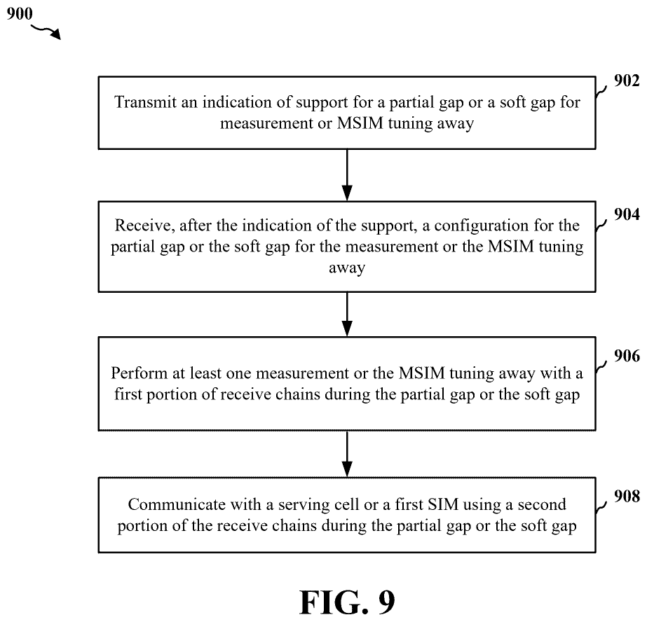

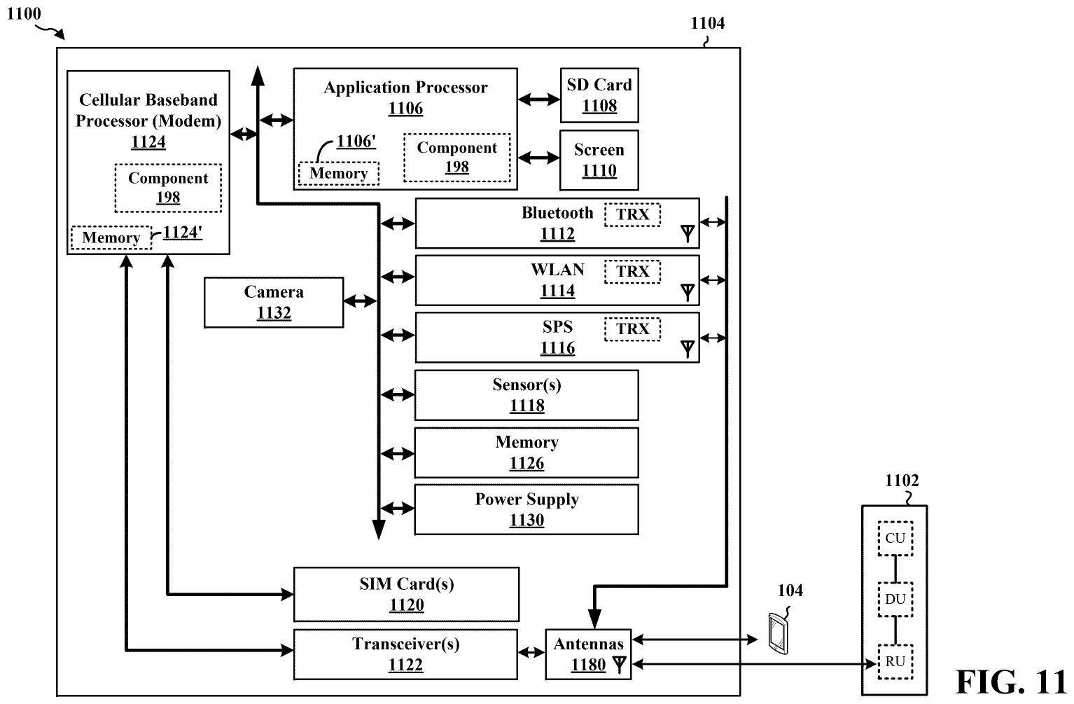

FIG. 9 is a flowchart 900 illustrating methods of wireless communication at a UE in accordance with various aspects of the present disclosure. The method may be performed by a UE. The UE may be the UE 104, 350, 702, 802, or the apparatus 1104 in the hardware implementation of FIG. 11. In some examples, by enabling a dynamic partial or soft gap based on needs and radio frequency conditions, such as varied XR traffic arrival times and volumes, the methods avoid delays in transmitting XR traffic, while preserving the quality of inter-frequency and IRAT measurements, thereby enhancing flexibility and efficiency of wireless communication. In some examples, by enabling soft gaps that allow ongoing transmission with reduced resources compared to full gaps that include a complete suspension of communication, the methods maintain stable and uninterrupted wireless connections. In some examples, by allowing the adaptive switch between full and soft gaps based on the network conditions or device preferences, the methods optimize resource allocation, thereby enhancing overall network efficiency and user experience.

As shown in FIG. 9, at 902, the UE may transmit an indication of support for a partial gap or a soft gap for measurement or MSIM tuning away. For example, the UE may transmit the indication of the support to a network entity. The network entity may be a base station, or a component of a base station, in the access network of FIG. 1 or a core network component (e.g., base station 102, 310, 704, 804; or the network entity 1102 in the hardware implementation of FIG. 11). FIG. 7 and FIG. 8 illustrate various aspects of the steps in connection with flowchart 900. For example, referring to FIG. 8, the UE 802 may, at 806, transmit to base station 804 an indication of support for a partial gap or a soft gap for measurement or MSIM tuning away. In some aspects, 902 may be performed by the gap management component 198.

At 904, the UE may receive, after the indication of the support, a configuration for the partial gap or the soft gap for the measurement or the MSIM tuning away. For example, referring to FIG. 8, the UE 802 may, at 814, receive a configuration for the partial gap or the soft gap for the measurement or the MSIM tuning away. In some aspects, 904 may be performed by the gap management component 198.

At 906, the UE may perform at least one measurement or the MSIM tuning away with a first portion of receive chains during the partial gap or the soft gap. For example, referring to FIG. 8, the UE 802 may, at 824, perform at least one measurement or the MSIM tuning away with a first portion of receive chains (e.g., receive chains 852 and 854) during the partial gap or the soft gap. Referring to FIG. 7, the UE 702 may perform at least one measurement or the MSIM tuning away with receive chains 752 and 754 during the partial gap or the soft gap. In some aspects, 906 may be performed by the gap management component 198.

At 908, the UE may communicate with a serving cell or a first SIM using a second portion of the receive chains during the partial gap or the soft gap. For example, referring to FIG. 8, the UE 802 may, at 826, communicate with a serving cell (base station 804) or a first SIM using a second portion of the receive chains (e.g., receive chains 842 and 844) during the partial gap or the soft gap. Referring to FIG. 7, the UE 702 may communicate with the base station 704 or a first SIM 724 using the receive chains 742 and 744 during the partial gap or the soft gap. In some aspects, 908 may be performed by the gap management component 198.

In some aspects, the UE may receive at least one of DCI or a MAC-CE indicating the partial gap or the soft gap. The use of the second portion of the receive chains for communication during the partial gap or the soft gap may be based on the reception of the DCI or the MAC-CE. For example, referring to FIG. 8, the UE 802 may, at 816, receive at least one of DCI or a MAC-CE indicating the partial gap or the soft gap. The use of the second portion of the receive chains (e.g., receive chains 842 and 844) for communication during the partial gap or the soft gap (at 824) may be based on the reception of the DCI or the MAC-CE.

In some aspects, the UE may receive an additional indication of a full gap or a hard gap; and perform the at least one measurement or the MSIM tuning away with a full receive chain during the full gap or the hard gap. For example, referring to FIG. 8, the UE 802 may, at 818, receive an additional indication of a full gap or a hard gap. The UE 802 may, at 820, perform the at least one measurement or the MSIM tuning away with a full receive chain (e.g., receive chains 842, 844, 852, 854) during the full gap or the hard gap.

In some aspects, the configuration may be included in RRC signaling that enables the partial gap or the soft gap or that configures one or more parameters associated with the partial gap or the soft gap. For example, referring to FIG. 8, the configuration (at 814) may be included in RRC signaling that enables the partial gap or the soft gap or that configures one or more parameters associated with the partial gap or the soft gap.

In some aspects, the at least one measurement may include one or more of: an inter-frequency measurement; an IRAT measurement; a position measurement; or a cell global identity (CGI) measurement. The MSIM tuning away may be for paging monitoring, collecting SIBs, performing cell reselection or registration with a second SIM. For example, referring to FIG. 7, the at least one measurement may include one or more of: an inter-frequency measurement; an IRAT measurement with base station 706; a position measurement; or a CGI measurement. The MSIM tuning away may be for paging monitoring, collecting SIBs, performing cell reselection or registration with a second SIM 726.

In some aspects, the UE may receive an additional indication of one or more of a multiple input multiple output (MIMO) layer reduction or a modulation and coding scheme (MCS) reduction. The communication during the partial gap or the soft gap may be based on the one or more of the MIMO layer reduction or the MCS reduction. For example, referring to FIG. 8, the UE 802 may, at 822, receive an additional indication of one or more of a MIMO layer reduction or an MCS reduction. The communication during the partial gap or the soft gap (e.g., at 826) may be based on the one or more of the MIMO layer reduction or the MCS reduction.

In some aspects, the UE may indicate, via radio resource control (RRC), a medium access control (MAC)-control element (MAC-CE), or channel state information (CSI), a gap preference between the partial gap or the soft gap and a full gap or a hard gap. For example, referring to FIG. 8, the UE 802 may, at 810, indicate, via RRC, a MAC-CE, or CSI, a gap preference between the partial gap or the soft gap and a full gap or a hard gap.

In some aspects, the UE may determine a gap preference based on at least one of a radio frequency condition, a traffic throughput, a latency condition, or an artificial intelligence (AI) output. For example, referring to FIG. 8, the UE 802, may, at 808, determine a gap preference based on at least one of a radio frequency condition, a traffic throughput, a latency condition, or an AI output.

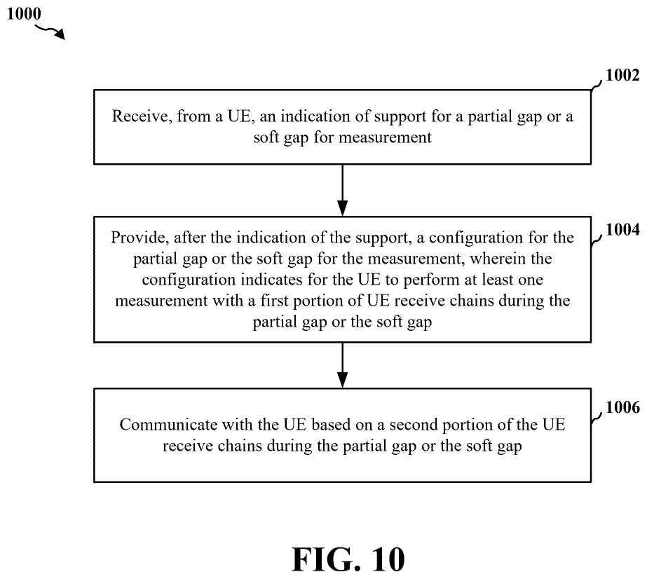

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 704, 804; or the network entity 1102 in the hardware implementation of FIG. 11). In some examples, by enabling a dynamic partial or soft gap based on needs and radio frequency conditions, such as varied XR traffic arrival times and volumes, the methods avoid delays in transmitting XR traffic, while preserving the quality of inter-frequency and IRAT measurements, thereby enhancing flexibility and efficiency of wireless communication. In some examples, by enabling soft gaps that allow ongoing transmission with reduced resources compared to full gaps that include a complete suspension of communication, the methods maintain stable and uninterrupted wireless connections. In some examples, by allowing the adaptive switch between full and soft gaps based on the network conditions or device preferences, the methods optimize resource allocation, thereby enhancing overall network efficiency and user experience.

As shown in FIG. 10, at 1002, the network entity may receive, from a UE, an indication of support for a partial gap or a soft gap for measurement or MSIM tuning away. The UE may be the UE 104, 350, 702, 802, or the apparatus 1104 in the hardware implementation of FIG. 11. FIG. 7 and FIG. 8 illustrate various aspects of the steps in connection with flowchart 1000. For example, referring to FIG. 8, the network entity (base station 804) may, at 806, receive, from a UE 802, an indication of support for a partial gap or a soft gap for measurement or MSIM tuning away. In some aspects, 1002 may be performed by the gap management component 199. At 1004, the network entity may provide, after the indication of the support, a configuration for the partial gap or the soft gap for the measurement or the MSIM tuning away. The configuration may indicate for the UE to perform at least one measurement or the MSIM tuning away with a first portion of UE receive chains during the partial gap or the soft gap. For example, referring to FIG. 8, the network entity (base station 804) may, at 814, provide a configuration for the partial gap or the soft gap for the measurement or the MSIM tuning away. The configuration may indicate for the UE 802 to perform, at 824, at least one measurement or the MSIM tuning away with a first portion of UE receive chains (e.g., receive chains 852 and 854) during the partial gap or the soft gap. Referring to FIG. 7, the UE 702 may perform at least one measurement (e.g., with base station 706) or the MSIM tuning away with receive chains 752 and 754 during the partial gap or the soft gap. In some aspects, 1004 may be performed by the gap management component 199.

At 1006, the network entity may communicate with the UE based on a second portion of the UE receive chains during the partial gap or the soft gap. For example, referring to FIG. 8, the network entity (base station 804) may, at 826, communicate with the UE 802 based on a second portion of the UE receive chains (e.g., receive chains 842 and 844) during the partial gap or the soft gap. Referring to FIG. 7, the UE 702 may communicate with the base station 704 or a first SIM 724 using the receive chains 742 and 744 during the partial gap or the soft gap. In some aspects, 1006 may be performed by the gap management component 199.

In some aspects, the network entity may provide at least one of DCI or a MAC-CE indicating the partial gap or the soft gap. The dynamical or adaptive switch between the partial gap or the soft gap and the full gap or the hard gap may be based on the DCI or the MAC-CE. For example, referring to FIG. 8, the network entity (base station 804) may, at 816, provide at least one of DCI or a MAC-CE indicating the partial gap or the soft gap. The dynamical or adaptive switch between the partial gap or the soft gap and the full gap or the hard gap (e.g., the switch between 820 and 824) may be based on the DCI or the MAC-CE.

In some aspects, the network entity may provide an additional indication of a full gap or a hard gap that indicates for the UE to perform the at least one of the measurement or the MSIM tuning away with a full receive chain during the full gap or the hard gap.

For example, referring to FIG. 8, the network entity (base station 804) may, at 818, provide an additional indication of a full gap or a hard gap that indicates for the UE 802 to perform, at 820, the at least one of the measurement or the MSIM tuning away with a full receive chain during the full gap or the hard gap.

In some aspects, the switch between the partial gap or the soft gap and the hard gap or the full gap may be based on a radio frequency condition, mobility, a traffic throughput, a latency condition, or a preference of the UE. For example, referring to FIG. 8, the switch between the partial gap or the soft gap and the hard gap or the full gap (e.g., the switch between 820 and 824) may be based on a radio frequency condition, mobility, a traffic throughput, a latency condition, or a preference of the UE 802.

In some aspects, the configuration may be included in RRC signaling that enables the partial gap or the soft gap or that configures one or more parameters associated with the partial gap or the soft gap. For example, referring to FIG. 8, the configuration (at 814) may be included in RRC signaling that enables the partial gap or the soft gap or that configures one or more parameters associated with the partial gap or the soft gap.

In some aspects, the one or more parameters may indicate one or more of: the gap type, the gap starting time, the gap length, the maximum number of uplink/downlink MIMO layers, or the MCS. For example, the gap type may be one of the partial/soft type or the hard/full type. The partial/soft type may indicate the UE uses a partial gap or a soft gap, during which the UE may use a first portion of the receive chains (e.g., receive chains 752 and 754) for measurement or MSIM tuning away and simultaneously use a second portion of the receive chains (e.g., receive chains 742 and 744) for communication with a serving cell (e.g., base station 704). The hard/full type may indicate that the UE may suspend the communication with the serving cell during the measurement or MSIM tuning away. The gap starting time may be the start time of a measurement gap (or an MSIM tuning away), such as start time S₂ 652 of measurement gap 650. The gap length may be the length of a measurement gap (or an MSIM tuning away), such as length l₂ 654 for measurement gap 650.

In some aspects, the at least one measurement may include one or more of: an inter-frequency measurement; an IRAT measurement; a position measurement; or a CGI measurement, and where the MSIM tuning away may be for paging monitoring, collecting SIBs, performing cell reselection or registration with a second SIM. For example, referring to FIG. 7 and FIG. 8, the at least one measurement may include one or more of: an inter-frequency measurement; an IRAT measurement with base station 706; a position measurement; or a CGI measurement, and the MSIM tuning away may be for paging monitoring, collecting SIBs, performing cell reselection or registration with a second SIM 726.

In some aspects, the network entity may provide an additional indication of one or more of a MIMO layer reduction or an MCS reduction. The communication during the partial gap or the soft gap may be based on the one or more of the MIMO layer reduction or the MCS reduction. For example, referring to FIG. 8, the network entity (base station 804) may, at 822, provide an additional indication of one or more of a MIMO layer reduction or an MCS reduction. The communication during the partial gap or the soft gap (at 826) may be based on the one or more of the MIMO layer reduction or the MCS reduction.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to transmit an indication of support for a partial gap or a soft gap for measurement or MSIM tuning away; receive, after the indication of the support, a configuration for the partial gap or the soft gap for the measurement or the MSIM tuning away; perform at least one measurement or the MSIM tuning away with a first portion of receive chains during the partial gap or the soft gap; and communicate with a serving cell or a first SIM using a second portion of the receive chains during the partial gap or the soft gap. The component 198 may be further configured to perform any of the aspects described in connection with the flowchart in FIG. 9, and/or performed by the UE 802 in FIG. 8. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for transmitting an indication of support for a partial gap or a soft gap for measurement or MSIM tuning away, means for receiving, after the indication of the support, a configuration for the partial gap or the soft gap for the measurement or the MSIM tuning away, means for performing at least one measurement or the MSIM tuning away with a first portion of receive chains during the partial gap or the soft gap, and means for communicating with a serving cell or a first SIM using a second portion of the receive chains during the partial gap or the soft gap. The apparatus 1104 may further include means for performing any of the aspects described in connection with the flowchart in FIG. 9, and/or aspects performed by the UE 802 in FIG. 8. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

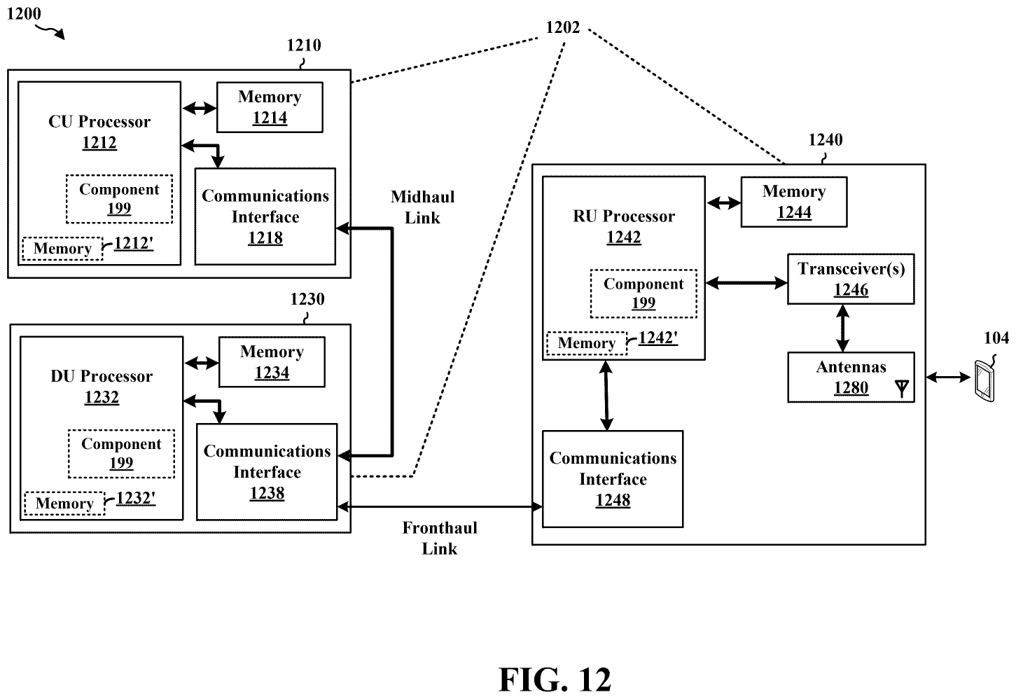

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, an indication of support for a partial gap or a soft gap for measurement or MSIM tuning away; provide, after the indication of the support, a configuration for the partial gap or the soft gap for the measurement or the MSIM tuning away, where the configuration indicates for the UE to perform at least one measurement or the MSIM tuning away with a first portion of UE receive chains during the partial gap or the soft gap; and communicate with the UE based on a second portion of the UE receive chains during the partial gap or the soft gap. The component 199 may be further configured to perform any of the aspects described in connection with the flowchart in FIG. 10, and/or performed by the base station 804 in FIG. 8. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for receiving, from a UE, an indication of support for a partial gap or a soft gap for measurement or MSIM tuning away, means for providing, after the indication of the support, a configuration for the partial gap or the soft gap for the measurement or the MSIM tuning away, where the configuration indicates for the UE to perform at least one measurement or the MSIM tuning away with a first portion of UE receive chains during the partial gap or the soft gap, and means for communicating with the UE based on a second portion of the UE receive chains during the partial gap or the soft gap. The network entity 1202 may further include means for performing any of the aspects described in connection with the flowchart in FIG. 10, and/or aspects performed by the base station 804 in FIG. 8. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means. This disclosure provides a method for wireless communication at a UE. The method may include transmitting an indication of support for a partial gap or a soft gap for measurement or MSIM tuning away; receiving, after the indication of the support, a configuration for the partial gap or the soft gap for the measurement or the MSIM tuning away; performing at least one measurement or the MSIM tuning away with a first portion of receive chains during the partial gap or the soft gap; and communicating with a serving cell or a first SIM using a second portion of the receive chains during the partial gap or the soft gap. In some examples, by enabling a dynamic partial or soft gap based on needs and radio frequency conditions, such as varied XR traffic arrival times and volumes, the methods avoid delays in transmitting XR traffic, while preserving the quality of inter-frequency and IRAT measurements, thereby enhancing flexibility and efficiency of wireless communication. In some examples, by enabling soft gaps that allow ongoing transmission with reduced resources compared to full gaps that include a complete suspension of communication, the methods maintain stable and uninterrupted wireless connections. In some examples, by allowing the adaptive switch between full and soft gaps based on the network conditions or device preferences, the methods optimize resource allocation, thereby enhancing overall network efficiency and user experience.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes transmitting an indication of support for a partial gap or a soft gap for measurement or multiple subscriber identity module (SIM) device (MSIM) tuning away; receiving, after the indication of the support, a configuration for the partial gap or the soft gap for the measurement or the MSIM tuning away; performing at least one measurement or the MSIM tuning away with a first portion of receive chains during the partial gap or the soft gap; and communicating with a serving cell or a first SIM using a second portion of the receive chains during the partial gap or the soft gap.
Aspect 2 is the method of aspect 1, where the method further includes receiving at least one of downlink control information (DCI) or a medium access control-control element (MAC-CE) indicating the partial gap or the soft gap, wherein use of the second portion of the receive chains for communication during the partial gap or the soft gap is based on reception of the DCI or the MAC-CE.
Aspect 3 is the method of any of aspects 1 to 2, where the method further includes receiving an additional indication of a full gap or a hard gap; and performing the at least one measurement or the MSIM tuning away with a full receive chain during the full gap or the hard gap.
Aspect 4 is the method of any of aspects 1 to 3, wherein the configuration is comprised in radio resource control (RRC) signaling that enables the partial gap or the soft gap or that configures one or more parameters associated with the partial gap or the soft gap.
Aspect 5 is the method of aspect 4, wherein the one or more parameters indicate one or more of: a gap type, wherein the gap type includes one of a partial/soft type or a hard/full type, a gap starting time, a gap length, a maximum number of uplink/downlink multiple input multiple output (MIMO) layers, or a modulation and coding scheme (MCS).
Aspect 6 is the method of any of aspects 1 to 5, wherein the at least one measurement includes one or more of: an inter-frequency measurement; an Inter-Radio Access Technology (IRAT) measurement; a position measurement; or a cell global identity (CGI) measurement, and wherein the MSIM tuning away is for paging monitoring, collecting system information blocks (SIBs), performing cell reselection or registration with a second SIM.
Aspect 7 is the method of any of aspects 1 to 6, where the method further includes receiving an additional indication of one or more of a multiple input multiple output (MIMO) layer reduction or a modulation and coding scheme (MCS) reduction, wherein communication during the partial gap or the soft gap is based on the one or more of the MIMO layer reduction or the MCS reduction.
Aspect 8 is the method any of aspects 1 to 7, where the method further includes indicating, via radio resource control (RRC), a medium access control (MAC)-control element (MAC-CE), or channel state information (CSI), a gap preference between the partial gap or the soft gap and a full gap or a hard gap.
Aspect 9 is the method any of aspects 1 to 7, where the method further includes determining a gap preference based on at least one of a radio frequency condition, a traffic throughput, a latency condition, or an artificial intelligence (AI) output.
Aspect 10 is an apparatus for wireless communication at a UE, comprising: a processing system that includes processor circuitry and memory circuitry that stores code and is coupled with the processor circuitry, the processing system configured to cause the UE to perform the method of one or more of aspects 1-9.
Aspect 11 is an apparatus for wireless communication at a UE, comprising: at least one memory; and at least one processor coupled to the at least one memory and, where the at least one processor, individually or in any combination, is configured to perform the method of any of aspects 1-9.
Aspect 12 is the apparatus for wireless communication at a UE, comprising means for performing each step in the method of any of aspects 1-9.
Aspect 13 is an apparatus of any of aspects 10-12, further comprising a transceiver configured to receive or to transmit in association with the method of any of aspects 1-9.
Aspect 14 is a computer-readable medium (e.g., a non-transitory computer-readable medium) storing computer executable code at a UE, the code when executed by at least one processor causes the at least one processor to, individually or in any combination, perform the method of any of aspects 1-9.
Aspect 15 is a method of wireless communication at a network entity. The method includes receiving, from a user equipment (UE), an indication of support for a partial gap or a soft gap for measurement or multiple subscriber identity module (SIM) device (MSIM) tuning away; providing, after the indication of the support, a configuration for the partial gap or the soft gap for the measurement or the MSIM tuning away, wherein the configuration indicates for the UE to perform at least one measurement or the MSIM tuning away with a first portion of UE receive chains during the partial gap or the soft gap; and communicating with the UE based on a second portion of the UE receive chains during the partial gap or the soft gap.
Aspect 16 is the method of aspect 15, where the method further includes providing at least one of downlink control information (DCI) or a medium access control-control element (MAC-CE) indicating the partial gap or the soft gap, wherein a dynamical or adaptive switch between the partial gap or the soft gap and a full gap or a hard gap is based on the DCI or the MAC-CE.
Aspect 17 is the method of any of aspects 15 to 16, where the method further includes providing an additional indication of a full gap or a hard gap that indicates for the UE to perform the at least one of the measurement or the MSIM tuning away with a full receive chain during the full gap or the hard gap.
Aspect 18 is the method of aspect 17, wherein a switch between the partial gap or the soft gap and the hard gap or the full gap is based on one or more of: a radio frequency condition, mobility, a traffic throughput, a latency condition, or a preference of the UE.
Aspect 19 is the method of aspect 15, wherein the configuration is comprised in radio resource control (RRC) signaling that enables the partial gap or the soft gap or that configures one or more parameters associated with the partial gap or the soft gap.
Aspect 20 is the method of any of aspects 15 to 19, wherein the at least one measurement includes one or more of: an inter-frequency measurement; an Inter-Radio Access Technology (IRAT) measurement; a position measurement; or a cell global identity (CGI) measurement, and wherein the MSIM tuning away is for paging monitoring, collecting system information blocks (SIBs), performing cell reselection or registration with a second SIM.
Aspect 21 is the method of any of aspects 15 to 20, where the method further includes providing an additional indication of one or more of a multiple input multiple output (MIMO) layer reduction or a modulation and coding scheme (MCS) reduction, wherein communication during the partial gap or the soft gap is based on the one or more of the MIMO layer reduction or the MCS reduction.
Aspect 22 is an apparatus for wireless communication at a network entity, comprising: a processing system that includes processor circuitry and memory circuitry that stores code and is coupled with the processor circuitry, the processing system configured to cause the network entity to perform the method of one or more of aspects 15-21.
Aspect 23 is an apparatus for wireless communication at a network entity, comprising: at least one memory; and at least one processor coupled to the at least one memory and, where the at least one processor, individually or in any combination, is configured to perform the method of any of aspects 15-21.
Aspect 24 is the apparatus for wireless communication at a network entity, comprising means for performing each step in the method of any of aspects 15-21.
Aspect 25 is an apparatus of any of aspects 22-24, further comprising a transceiver configured to receive or to transmit in association with the method of any of aspects 15-21.
Aspect 26 is a computer-readable medium (e.g., a non-transitory computer-readable medium) storing computer executable code at a network entity, the code when executed by at least one processor causes the at least one processor to, individually or in any combination, perform the method of any of aspects 15-21.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit an indication of support for a partial gap or a soft gap for measurement or multiple subscriber identity module (SIM) device (MSIM) tuning away;
receive, after the indication of the support, a configuration for the partial gap or the soft gap for the measurement or the MSIM tuning away;
perform at least one measurement or the MSIM tuning away with a first portion of receive chains during the partial gap or the soft gap; and
communicate with a serving cell or a first SIM using a second portion of the receive chains during the partial gap or the soft gap.

2. The apparatus of claim 1, further comprising a transceiver coupled to the at least one processor, wherein to transmit the indication of the support, the at least one processor, individually or in any combination, is configured to cause the UE to transmit the indication of the support via the transceiver, and wherein the at least one processor, individually or in any combination, is further configured to cause the UE to:
receive at least one of downlink control information (DCI) or a medium access control-control element (MAC-CE) indicating the partial gap or the soft gap, wherein use of the second portion of the receive chains for communication during the partial gap or the soft gap is based on reception of the DCI or the MAC-CE.

3. The apparatus of claim 1, wherein the at least one processor, individually or in any combination, is further configured to cause the UE to:
receive an additional indication of a full gap or a hard gap; and
perform the at least one measurement or the MSIM tuning away with a full receive chain during the full gap or the hard gap.

4. The apparatus of claim 1, wherein the configuration is comprised in radio resource control (RRC) signaling that enables the partial gap or the soft gap or that configures one or more parameters associated with the partial gap or the soft gap.

5. The apparatus of claim 4, wherein the one or more parameters indicate one or more of:
a gap type, wherein the gap type includes one of a partial/soft type or a hard/full type,
a gap starting time,
a gap length,
a maximum number of uplink/downlink multiple input multiple output (MIMO) layers, or
a modulation and coding scheme (MCS).

6. The apparatus of claim 1, wherein the at least one measurement includes one or more of:
an inter-frequency measurement;
an Inter-Radio Access Technology (IRAT) measurement;
a position measurement; or
a cell global identity (CGI) measurement, and
wherein the MSIM tuning away is for paging monitoring, collecting system information blocks (SIBs), performing cell reselection or registration with a second SIM.

7. The apparatus of claim 1, wherein the at least one processor, individually or in any combination, is further configured to cause the UE to:
receive an additional indication of one or more of a multiple input multiple output (MIMO) layer reduction or a modulation and coding scheme (MCS) reduction, wherein communication during the partial gap or the soft gap is based on the one or more of the MIMO layer reduction or the MCS reduction.

8. The apparatus of claim 1, wherein the at least one processor, individually or in any combination, is configured to cause the UE to:
indicate, via radio resource control (RRC), a medium access control (MAC)-control element (MAC-CE), or channel state information (CSI), a gap preference between the partial gap or the soft gap and a full gap or a hard gap.

9. The apparatus of claim 1, wherein the at least one processor, individually or in any combination, is configured to cause the UE to:
determine a gap preference based on at least one of a radio frequency condition, a traffic throughput, a latency condition, or an artificial intelligence (AI) output.

10. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
receive, from a user equipment (UE), an indication of support for a partial gap or a soft gap for measurement or multiple subscriber identifier module (SIM) device (MSIM) tuning away;
provide, after the indication of the support, a configuration for the partial gap or the soft gap for the measurement or the MSIM tuning away, wherein the configuration indicates for the UE to perform at least one measurement or the MSIM tuning away with a first portion of UE receive chains during the partial gap or the soft gap; and
communicate with the UE based on a second portion of the UE receive chains during the partial gap or the soft gap.

11. The apparatus of claim 10, further comprising a transceiver coupled to the at least one processor, wherein to receive the indication of the support, the at least one processor, individually or in any combination, is configured to cause the network entity to receive the indication of the support via the transceiver, and wherein the at least one processor, individually or in any combination, is further configured to cause the network entity to:
provide at least one of downlink control information (DCI) or a medium access control-control element (MAC-CE) indicating the partial gap or the soft gap, wherein a dynamical or adaptive switch between the partial gap or the soft gap and a full gap or a hard gap is based on the DCI or the MAC-CE.

12. The apparatus of claim 10, wherein the at least one processor, individually or in any combination, is further configured to cause the network entity to:
provide an additional indication of a full gap or a hard gap that indicates for the UE to perform the at least one measurement or the MSIM tuning away with a full receive chain during the full gap or the hard gap.

13. The apparatus of claim 12, wherein a switch between the partial gap or the soft gap and the hard gap or the full gap is based on one or more of: a radio frequency condition, mobility, a traffic throughput, a latency condition, or a preference of the UE.

14. The apparatus of claim 10, wherein the configuration is comprised in radio resource control (RRC) signaling that enables the partial gap or the soft gap or that configures one or more parameters associated with the partial gap or the soft gap.

15. The apparatus of claim 10, wherein the at least one measurement includes one or more of:
an inter-frequency measurement;
an Inter-Radio Access Technology (IRAT) measurement;
a position measurement; or
a cell global identity (CGI) measurement, and
wherein the MSIM tuning away is for paging monitoring, collecting system information blocks (SIBs), performing cell reselection, registration with a second SIM.

16. The apparatus of claim 10, wherein the at least one processor, individually or in any combination, is further configured to cause the network entity to:
provide an additional indication of one or more of a multiple input multiple output (MIMO) layer reduction or a modulation and coding scheme (MCS) reduction, wherein communication during the partial gap or the soft gap is based on the one or more of the MIMO layer reduction or the MCS reduction.

17. A method of wireless communication at a user equipment (UE), comprising:
transmitting an indication of support for a partial gap or a soft gap for measurement or multiple subscriber identity module (SIM) device (MSIM) tuning away;
receiving, after the indication of the support, a configuration for the partial gap or the soft gap for the measurement or the MSIM tuning away;
performing at least one measurement or the MSIM tuning away with a first portion of receive chains during the partial gap or the soft gap; and
communicating with a serving cell or a first SIM using a second portion of the receive chains during the partial gap or the soft gap.

18. The method of claim 17, further comprising:
receiving at least one of downlink control information (DCI) or a medium access control-control element (MAC-CE) indicating the partial gap or the soft gap, wherein use of the second portion of the receive chains for communication during the partial gap or the soft gap is based on reception of the DCI or the MAC-CE.

19. The method of claim 17, further comprising:
receiving an additional indication of a full gap or a hard gap; and
performing the at least one measurement or the MSIM tuning away with a full receive chain during the full gap or the hard gap.

20. The method of claim 17, wherein the configuration is comprised in radio resource control (RRC) signaling that enables the partial gap or the soft gap or that configures one or more parameters associated with the partial gap or the soft gap.
